(19) United States
(12) Patent Application Publication
(10) Pub. No.: US 2021/0115966 A1
(43) Pub. Date: Apr. 22, 2021

(54) INDUCTION-HARDENED CRANKSHAFT AND METHOD OF MANUFACTURING ROUGHLY SHAPED MATERIAL FOR INDUCTION-HARDENED CRANKSHAFT

(71) Applicant: NIPPON STEEL CORPORATION, Tokyo (JP)

(72) Inventors: Manabu KUBOTA, Tokyo (JP); Taketo MAEJIMA, Tokyo (JP)

(73) Assignee: Nippon Steel Corporation, Tokyo (JP)

(21) Appl. No.: 16/981,154

(22) PCT Filed: Jun. 13, 2019
(86) PCT No.: PCT/JP2019/023491

§ 371 Date: Sep. 15, 2020

(30) Foreign Application Priority Data
Jun. 28, 2018 (JP) 2018-123664

(51) Int. Cl. F16C 3/08; C21D 9/30; C21D 6/00; C21D 1/42; C22C 38/26; C22C 38/06; C22C 38/04; C22C 38/02; C22C 38/00

(52) U.S. Cl. CPC F16C 3/08; C21D 9/30; C21D 6/002; C21D 6/005; C21D 6/008; C21D 1/42; C21D 2211/001; C22C 38/06; C22C 38/04; C22C 38/02; C22C 38/002; C22C 38/001; C21D 2211/008; C22C 38/26

(57) ABSTRACT

An induction-hardened crankshaft is provided that offers an excellent balance of fatigue strength, machinability and quench-cracking resistance. An induction-hardened crankshaft has a chemical composition of, in mass %: 0.30 to 0.60% C; 0.01 to 1.50% Si; 0.4 to 2.0% Mn; 0.01 to 0.50% Cr; 0.001 to 0.06% Al; 0.001 to 0.02% N; up to 0.03% P; 0.005 to 0.20% S; 0.005 to 0.060% Nb; and balance Fe and impurities, the non-induction-hardened portion having a microstructure mainly composed of ferrite-pearlite and having a fraction of ferrite Fα satisfying the expression (1) provided below, the induction-hardened portion having a microstructure mainly composed of martensite or tempered martensite, and having a prior austenite grain diameter not larger than 30 μm,

Fα≥150×[C %]+84 (1),
where the C content in mass % in the induction-hardened crankshaft is substituted for [C %].

### TECHNICAL FIELD

The present invention relates to an induction-hardened crankshaft and a method of manufacturing a roughly shaped material for an induction-hardened crankshaft.

### BACKGROUND ART

A crankshaft is manufactured by hot-forging a steel material to produce a roughly shaped material, performing mechanical processes such as cutting, grinding and/or punching, and performing a surface-hardening treatment, such as induction hardening, as necessary.

A crankshaft that has undergone a surface-hardening treatment by induction hardening will be hereinafter referred to as “induction-hardened crankshaft”, and a roughly shaped crankshaft material used to make an induction-hardened crankshaft as “roughly shaped material for induction-hardened crankshaft”.

In order to improve the fatigue strength of an induction-hardened crankshaft, it is necessary to improve not only the hardness of the portions that have undergone induction hardening (hereinafter referred to as “induction-hardened portions”), but also that of the portions that have not undergone induction hardening (hereinafter referred to as “non-induction-hardened portions”). To improve the hardness of both the induction-hardened portions and non-induction-hardened portions, it is effective to increase the C content of the steel material. However, increasing the C content may cause problems such as decreased machinability and increased susceptibility to quench cracking.

One known approach to improving hardness without increasing C content is to add V to the steel material, where VC effects precipitation strengthening. However, V is a relatively expensive element, and the use of V has a high risk of price fluctuation; thus, from a commercial viewpoint, it is preferable to avoid using V.

Japanese Patent Nos. 4699341 and 4699342 teach causing precipitation of ultrafine precipitates of Nb, Ti and V (with grain diameters not larger than 15 nm) to improve the tensile strength and fatigue limit ratio of a steel part.

To produce such ultrafine precipitates, Patent No. 4699341 teaches hot forging followed by cooling at an average cooling rate of 60° C./min or higher through the range down to 650° C., before cooling at an average cooling rate of 10° C./min or lower through the range 650° C. to 500° C. Similarly, Patent No. 4699342 teaches hot rolling followed by cooling at an average cooling rate of 120° C./min or higher through the range down to 650° C., before cooling at an average cooling rate of 60° C./min or lower through the range 650° C. to 500° C.

### DISCLOSURE OF THE INVENTION

Patent Nos. 4699341 and 4699342 relate to non-heat-treated steel parts, and do not consider quench-cracking resistance.

An object of the present invention is to provide an induction-hardened crankshaft that offers an excellent balance of fatigue strength, machinability and quench-cracking resistance. Another object of the present invention is to provide a method of manufacturing a roughly shaped material for an induction-hardened crankshaft that offers an excellent balance of fatigue strength, machinability and quench-cracking resistance during induction hardening.

An induction-hardened crankshaft according to an embodiment of the present invention is an induction-hardened crankshaft including a non-induction-hardened portion and an induction-hardened portion, having a chemical composition of, in mass %: 0.30 to 0.60% C; 0.01 to 1.50% Si; 0.4 to 2.0% Mn; 0.01 to 0.50% Cr; 0.001 to 0.06% Al; 0.001 to 0.02% N; up to 0.03% P; 0.005 to 0.20% S; 0.005 to 0.060% Nb; and balance Fe and impurities, the non-induction-hardened portion having a microstructure mainly composed of ferrite-pearlite and having a fraction of ferrite Fα satisfying the expression (1) provided below, the induction-hardened portion having a microstructure mainly composed of martensite or tempered martensite, and having a prior austenite grain diameter not larger than 30 μm,

Fα≥−150×[C %]+84 (1),

where the C content in mass % in the induction-hardened crankshaft is substituted for [C %].

A method of manufacturing a roughly shaped material for an induction-hardened crankshaft according to an embodiment of the present invention includes the steps of: preparing a steel material having a chemical composition of, in mass %: 0.30 to 0.60% C; 0.01 to 1.50% Si; 0.4 to 2.0% Mn; 0.01 to 0.50% Cr; 0.001 to 0.06% Al; 0.001 to 0.02% N; up to 0.03% P; 0.005 to 0.20% S; 0.005 to 0.060% Nb; and balance Fe and impurities; hot-forging the steel material in such a manner that, immediately before finish forging, the steel material is at a temperature higher than 800° C. and lower than 1100° C.; and, after the hot forging, cooling the steel material at an average cooling rate not higher than 0.07° C./s through a temperature range of 800 to 650° C.

The present invention provides an induction-hardened crankshaft with improved fatigue strength, machinability and quench-cracking resistance.

### BRIEF DESCRIPTION OF THE DRAWINGS

FIG. 1 is a flow diagram of a method of manufacturing a roughly shaped material for an induction-hardened crankshaft according to an embodiment of the present invention.

FIG. 2 is a heat pattern for hot-forging simulation testing using a processing formastor.

FIG. 3 is another heat pattern for hot-forging simulation testing using a processing formastor.

FIG. 4A shows the microstructure of a test specimen for a structure observation test.

FIG. 4B shows the microstructure of a test specimen for a structure observation test.

FIG. 4C shows the microstructure of a test specimen for a structure observation test.

FIG. 5A shows the microstructure of a test specimen for a structure observation test.

FIG. 5B shows the microstructure of a test specimen for a structure observation test.

FIG. 5C shows the microstructure of a test specimen for a structure observation test.

FIG. 6A is a graph showing the relationship between the finish-forging temperature for steel type C and the fraction of ferrite in this steel.

FIG. 6B is a graph showing the relationship between the finish-forging temperature for steel type D and the fraction of ferrite in this steel.

FIG. 6C is a graph showing the relationship between the finish-forging temperature for steel type E and the fraction of ferrite in this steel.

FIG. 7A is a graph showing the relationship between the finish-forging temperature for steel type C and the Vickers hardness of this steel.

FIG. 7B is a graph showing the relationship between the finish-forging temperature for steel type D and the Vickers hardness of this steel.

FIG. 7C is a graph showing the relationship between the finish-forging temperature for steel type E and the Vickers hardness of this steel.

FIG. 8 is a graph showing the relationship between Vickers hardness and endurance ratio.

FIG. 9A shows the microstructure of a test specimen produced by hot-forging steel type C at 1100° C., after a simulated heat treatment by induction hardening.

FIG. 9B shows the microstructure of a test specimen produced by hot-forging steel type C at 1000° C., after a simulated heat treatment by induction hardening.

FIG. 9C shows the microstructure of a test specimen produced by hot-forging steel type C at 900° C., after a simulated heat treatment by induction hardening.

FIG. 9D shows the microstructure of a test specimen produced by hot-forging steel type C at 800° C., after a simulated heat treatment by induction hardening.

FIG. 10A shows the microstructure of a test specimen produced by hot-forging steel type D at 1100° C., after a simulated heat treatment by induction hardening.

FIG. 10B shows the microstructure of a test specimen produced by hot-forging steel type D at 1000° C., after a simulated heat treatment by induction hardening.

FIG. 10C shows the microstructure of a test specimen produced by hot-forging steel type D at 900° C., after a simulated heat treatment by induction hardening.

FIG. 10D shows the microstructure of a test specimen produced by hot-forging steel type D at 800° C., after a simulated heat treatment by induction hardening.

FIG. 11A shows the microstructure of a test specimen produced by hot-forging steel type E at 1100° C., after a simulated heat treatment by induction hardening.

FIG. 11B shows the microstructure of a test specimen produced by hot-forging steel type E at 1000° C., after a simulated heat treatment by induction hardening.

FIG. 11C shows the microstructure of a test specimen produced by hot-forging steel type E at 900° C., after a simulated heat treatment by induction hardening.

FIG. 11D shows the microstructure of a test specimen produced by hot-forging steel type E at 800° C., after a simulated heat treatment by induction hardening.

### EMBODIMENTS FOR CARRYING OUT THE INVENTION

The present inventors attempted to find a way to improve the fatigue strength, machinability, and quench-cracking resistance of an induction-hardened crankshaft, and obtained the following findings.

An induction-hardened crankshaft includes induction-hardened portions and non-induction-hardened portions (i.e., base material). The induction-hardened portions have a microstructure mainly composed of martensite or tempered martensite, whereas the non-induction-hardened portions have a microstructure mainly composed of ferrite-pearlite.

Increasing C content reduces machinability because the increased C increases hardness and, in addition, decreases the fraction of ferrite in the ferrite-pearlite. Meanwhile, it has been reported that, when steel materials with the same C content are compared, the fatigue strength remains substantially the same even when the fraction of ferrite is increased, or may even improve (NAKAMYO Satoru et al., “Development of High Strength Steel with Superior Machinability for Induction Hardening”, Sanyo Technical Report, Vol. 11 (2004), No. 1, pp. 57 to 60). This is presumably because the increased fraction of ferrite essentially means finer crystal grains.

Accordingly, with substantially the same C content, increasing the fraction of ferrite over the normal ferrite-pearlite will improve both machinability and fatigue strength. Specifically, if the fraction of ferrite Fα satisfies the following expression, (1), a steel material will be obtained that offers an excellent balance of fatigue strength and machinability:

Fα≥−150×[C %]+84 (1),

where the C content in mass % in the induction-hardened crankshaft is substituted for [C %].

It has been reported that lowering temperatures for finish forging in the hot forging step increases the fraction of ferrite (FUJIWARA Masanao et al., “Controlled Forging Technique for Mechanical Properties Using Thermo-Mechanical Heat Treatment”, Denki-Seiko (Daido Technical Reports on Special Steel), Vol. 82, No. 2 (2011), pp. 157 to 163). However, lowering temperatures for forging leads to a significant reduction in the life of the die. For a production viewpoint, it is preferable to be able to increase the fraction of ferrite without excessively lowering temperatures for forging.

The present inventors found that having an appropriate Nb content in the steel material will increase the fraction of ferrite even when temperatures for forging are not excessively reduced. This presumably occurs with the following mechanism.

The austenite grains (hereinafter referred to as “γ grains”)created by the effects of hot forging try to relieve the forging-induced strains by recrystallization. At this time, the Nb(C,N) that has precipitated in the γ grains suppresses the grain growth of the γ grains after recrystallization. This results in finer γ grains. As the γ grains become finer, the number per unit area of crystal grain boundaries, which provide ferrite nucleation sites, increases, increasing the fraction of ferrite.

Nb contributes to making the structure after induction hardening finer. That is, having an appropriate Nb content results in a finer structure for the induction-hardened portions. This improves the fatigue strength and quench-cracking resistance of the induction-hardened portions, as well.

The present inventors further found that if, after hot forging, the average cooling rate through the temperature range 800 to 650° C. is 0.07° C./s or lower, the fraction of ferrite can be further increased.

The present invention was made based on all these findings. Now, an induction-hardened crankshaft and a method of manufacturing a roughly shaped material for an induction-hardened crankshaft according to embodiments of the present invention will be described in detail.

[Induction-Hardened Crankshaft]

[Chemical Composition]

The induction-hardened crankshaft according to the present embodiment has a chemical composition as described below. In the following description, “%” for the content of each element means mass percent.

C: 0.30 to 0.60%

Carbon (C) improves the hardness of the induction-hardened and non-induction-hardened portions to contribute to improvements in fatigue strength. On the other hand, if the C content is too high, quench-cracking resistance and machinability will be low. In view of this, the C content is to be 0.30 to 0.60%. The lower limit for C content is preferably 0.35%, and more preferably 0.37%. The upper limit for C content is preferably 0.55%, and more preferably 0.51%.

Si: 0.01 to 1.50%

Silicon (Si) has deoxidization effects, as well as the effect of strengthening ferrite. On the other hand, if the Si content is too high, machinability will be low. In view of this, the Si content is to be 0.01 to 1.50%. The lower limit for Si content is preferably 0.05%, and more preferably 0.40%. The upper limit for Si content is preferably 1.00%, and more preferably 0.60%.

Mn: 0.4 to 2.0%

Manganese (Mn) increases the hardenability of steel and contributes to improvements in the hardness of the induction-hardened portions. On the other hand, if the Mn content is too high, bainite is produced during the cooling process after hot forging, which decreases machinability. In view of this, the Mn content is to be 0.4 to 2.0%. The lower limit for Mn content is preferably 1.0%, and more preferably 1.2%. The upper limit for Mn content is preferably 1.8%, and more preferably 1.6%.

Cr: 0.01 to 0.50%

Chromium (Cr) increases the hardenability of steel and contributes to improvements in the hardness of the induction-hardened portions. On the other hand, if the Cr content is too high, bainite is produced during the cooling process after hot forging, which decreases machinability. In view of this, the Cr content is to be 0.01 to 0.50%. The lower limit for Cr content is preferably 0.05%, and more preferably 0.10%. The upper limit for Cr content is preferably 0.30%, and more preferably 0.20%.

Al: 0.001 to 0.06%

Aluminum (Al) has deoxidization effects. On the other hand, if the Al content is too high, excessive amounts of alumina-based inclusions are produced, which decreases machinability. In view of this, the Al content is to be 0.001 to 0.06%. The lower limit for Al content is preferably 0.002%. The upper limit for Al content is preferably 0.05%, and more preferably 0.04%.

N: 0.001 to 0.02%

Nitrogen (N) forms nitrides and/or carbonitrides to contribute to making the crystal grains finer. On the other hand, if the N content is too high, the hot ductility of the steel will be low. In view of this, the N content is to be 0.001 to 0.02%. The lower limit for N content is preferably 0.002%. The upper limit for N content is preferably 0.015%, and more preferably 0.01%.

P: up to 0.03%

Phosphorous (P) is an impurity. P decreases the quench-cracking resistance of steel. In view of this, the P content is to be not higher than 0.03%. The P content is preferably not higher than 0.025%, and more preferably not higher than 0.02%.

S: 0.005 to 0.20%

Sulfur (S) forms MnS and increases the machinability of steel. On the other hand, if the S content is too high, the hot workability of steel will be low. In view of this, the S content is to be 0.005 to 0.20%. The lower limit for S content is preferably 0.010%, and more preferably 0.030%. The upper limit for S content is preferably 0.15%, and more preferably 0.10%.

Nb: 0.005 to 0.060%

Niobium (Nb) forms Nb(C,N) to make the γ grains finer. This increases the number per unit area of grain boundaries, which provide ferrite nucleation sites, and increases the fraction of ferrite. This results in improvements in the fatigue strength and machinability of the non-induction-hardened portions. Also, Nb contributes to making the microstructure after induction hardening, i.e., microstructure of the induction-hardened portions, finer. This improves the fatigue strength and quench-cracking resistance of the induction-hardened portions. On the other hand, with an excessively high Nb content, some Nb cannot dissolve in the matrix during the heating in the hot-forging step and forms coarse undissolved NbC, and thus cannot contribute to making the grains finer. Further, an excessive amount of Nb may cause cracking during casting. In view of this, the Nb content is to be 0.005 to 0.060%. The lower limit for Nb content is preferably 0.008%, and more preferably 0.010%. The upper limit for Nb content is preferably 0.050%, and more preferably 0.030%.

The balance of the chemical composition of the induction-hardened crankshaft according to the present embodiment is Fe and impurities. As used herein, impurity means an element originating from ore or scrap used as raw material for steel or an element that has entered from the environment or the like during the manufacturing process.

[Microstructure]

The induction-hardened crankshaft according to the present embodiment includes induction-hardened portions and non-induction-hardened portions.

Generally, the induction hardening of a crankshaft occurs in such a manner that only the surface layer of the crankshaft is affected. That is, the core of the crankshaft typically remains non-induction-hardened. Further, the heating process for induction hardening may be performed only on portions that particularly require fatigue strength and/or wear resistance (for example, journal) such that the portions that have not been subjected to the heating process, including the surface layer, remain non-induction-hardened. As used herein, the term “non-induction-hardened portion” means both of these types.

The non-induction-hardened portions have a microstructure mainly composed of ferrite-pearlite. The proportion in area of ferrite-pearlite in the non-induction-hardened portions is preferably not lower than 90%, and more preferably not lower than 95%.

In the induction-hardened crankshaft according to the present embodiment, the fraction of ferrite Fα of the ferrite-pearlite satisfies the following expression, (1):

Fα≥−150×[C %]+84 (1),

where the C content in mass % in the induction-hardened crankshaft is substituted for [C %].

Fraction of ferrite is measured in the following manner: a specimen is extracted from the non-induction-hardened portions, where a cross section containing a direction perpendicular to the surface of the crankshaft serves as the surface to be observed. The surface to be observed is polished and etched by a mixed solution of ethanol and nitric acid (i.e., Nital). Optical microscopy (with a magnifying power of 100 to 200 for observation) is used to measure the proportion in area of ferrite in the etched surface using image analysis. The measured proportion in area of ferrite (%) is treated as a fraction of ferrite.

The induction-hardened portions have a microstructure mainly composed of martensite or tempered martensite. The proportion in area of martensite or tempered martensite in the induction-hardened portions is preferably not lower than 90%, and more preferably not lower than 95%.

In the induction-hardened crankshaft according to the present embodiment, the prior austenite grain diameter in the martensite or tempered martensite (hereinafter referred to as “prior γ grain diameter”) is not larger than 30 μm. Prior γ grain diameters not larger than 30 um provide good fatigue strength and quench-cracking resistance. The prior γ grain diameter is preferably not larger than 25 μm, and more preferably not larger than 20 μm.

The prior γ grain diameter is measured in the following manner: A specimen is extracted from the induction-hardened portions, where a cross section containing a direction perpendicular to the surface of the crankshaft serves as the surface to be observed. The surface to be observed is polished and etched by a saturated aqueous solution of picric acid to cause prior austenite grain boundaries to appear. The intercept method is used to calculate the average grain diameter. Specifically, a straight line with a total length L is drawn and the number of crystal grains that cross this straight line, n_{L}, is determined, and the intercept length (L/n_{L}) is calculated. The intercept lengths (L/n_{L}) for five or more straight lines are determined and the arithmetic average thereof is treated as the average grain diameter.

[Method of Manufacturing Induction-Hardened Crankshaft]

Although not limiting, the induction-hardened crankshaft according to the present embodiment can be manufactured by subjecting a roughly shaped material for a crankshaft, described below, to mechanical processes such as cutting, grinding and punching, before performing induction hardening. After the induction hardening, tempering may be performed as necessary.

[Method of Manufacturing Roughly Shaped Material for Induction-Hardened Crankshaft]

A method of manufacturing a roughly shaped material for an induction-hardened crankshaft suitable for the induction-hardened crankshaft according to the present embodiment will be described below.

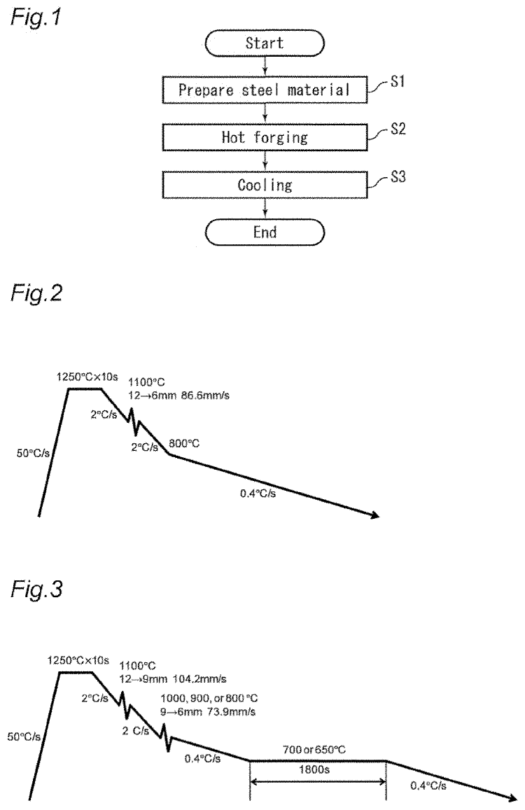

FIG. 1 is a flow diagram of the method of manufacturing a roughly shaped material for an induction-hardened crankshaft according to the present embodiment. This manufacture method includes the steps of preparing a steel material (step S1), hot-forging the steel material (step S2), and cooling the hot-forged steel material (step S3).

First, a steel material with a chemical composition as described above is prepared (step S1). For example, a steel with a chemical composition as described above is smelted and subjected to continuous casting or blooming to produce a steel billet. In addition to continuous casting or blooming, the steel billet may be subjected to hot working, cold working and/or heat treatment, for example.

Next, the steel material is hot forged into a rough crankshaft shape (step S2).

Although not limiting, the heating conditions for the hot forging may be described as a heating temperature of 1000 to 1300° C., for example, and a holding time of 1 second to 20 minutes, for example. The heating temperature is preferably 1220 to 1280° C., and more preferably 1240 to 1260° C.

In the present embodiment, the temperature immediately before finish forging (more particularly, surface temperature of the steel material immediately before finish forging) is higher than 800° C. and lower than 1100° C. The hot forging step may be divided into a plurality of runs. In such implementations, it is sufficient if the temperature immediately before the last run of finish hot forging is higher than 800° C. and lower than 1100° C.

If the temperature immediately before finish forging (hereinafter simply referred to as “finish forging temperature”) is not lower than 1100° C., the γ grains coarsen, making it impossible to obtain a microstructure with a high fraction of ferrite after cooling. On the other hand, if the finish forging temperature is not higher than 800° C., the deformation resistance significantly increases and thus significantly reduces the life of the mold, which makes industrial production difficult, if not impossible. The lower limit for finish forging temperature is preferably 850° C., and more preferably 900° C. The upper limit for finish forging temperature is preferably 1075° C., and more preferably 1025° C.

The steel material as hot-forged is cooled (step S3). This occurs at an average cooling rate not higher than 0.07° C./s through the temperature range 800° C. to 650° C. This causes ferrite to precipitate on the austenite grain boundaries, which increases the fraction of ferrite after cooling.

It is sufficient if this cooling occurs at an average cooling rate not higher than 0.07° C./s through the temperature range 800 to 650° C.; slow cooling may be performed through the temperature range 800 to 650° C., or retention may be performed where the steel is held at a desired temperature in the range of 800 to 650° C. for a predetermined period of time. Any cooling rate may be used for the temperature range lower than 650° C.

These steps results in a roughly shaped material for an induction-hardened crankshaft. The roughly shaped material for an induction-hardened crankshaft manufactured according to the present embodiment has a microstructure mainly composed of ferrite-pearlite, and has a high fraction of ferrite.

The induction-hardened crankshaft and the method of manufacturing a roughly shaped material for an induction-hardened crankshaft according to embodiments of the present invention have been described. These embodiments provide an induction-hardened crankshaft that offers an excellent balance of fatigue strength, machinability and quench-cracking resistance.

### EXAMPLES

The present invention will now be more specifically described by means of examples. The present invention is not limited to these examples.

[Microstructure Observation Testing]

First, the relationship was investigated between the chemical composition of, and forging conditions for, steel materials, on one hand, and the microstructure of these steel materials.

Steels having the chemical compositions shown in Table 1 were smelted by a 150 kg vacuum induction melting (VIM) furnace to produce ingots. These ingots were subjected to hot forging to produce round bars with an outer diameter of 35 mm. These round bars were subjected to a normalization process, in which the bars were held at 950° C. for 30 minutes and then air-cooled, to produce test materials.

TABLE 1

| Steel | | Chemical composition (in mass %, balance Fe and impurities) | | | | | | | | | |
|---|---|---|---|---|---|---|---|---|---|---|---|
| type | | C | Si | Mn | P | S | Cr | Al | Nb | N | Category |
| A | 0.38 C | 0.38 | 0.49 | 1.49 | 0.014 | 0.059 | 0.16 | 0.003 | — | 0.0030 | comp. ex. |
| B | 0.38 C - 0.02 Nb | 0.38 | 0.49 | 1.48 | 0.013 | 0.059 | 0.16 | 0.004 | 0.019 | 0.0036 | inv. ex. |
| C | 0.5 C | 0.51 | 0.48 | 1.49 | 0.010 | 0.061 | 0.15 | 0.005 | — | 0.0040 | comp. ex. |
| D | 0.5 C - 0.01 Nb | 0.51 | 0.47 | 1.48 | 0.011 | 0.061 | 0.15 | 0.005 | 0.010 | 0.0037 | inv. ex. |
| E | 0.5 C - 0.02 Nb | 0.51 | 0.47 | 1.48 | 0.011 | 0.060 | 0.15 | 0.007 | 0.020 | 0.0043 | inv. ex. |

Test specimens with an outer diameter of 8 mm and a height of 12 mm were extracted from these test materials, and hot-forging simulation experiments were conducted using a processing formastor. FIGS. 2 and 3 show heat patterns for hot-forging simulation tests using a processing formastor.

The heat pattern of FIG. 2 simulates a common set of forging conditions. According to this heat pattern, the test specimen was held at 1250° C. for 10 seconds, and subjected to a hot compression process that simulated forging at 1100° C. to a height of 6 mm, before being air-cooled to room temperature.

In the heat pattern of FIG. 3, the finish-forging temperature is lower and a retention process at 700° C. or 650° C. is added. According to this heat pattern, the test specimen was held at 1250° C. for 10 seconds, and subjected to a first hot compression process that simulated rough forging at 1100° C. to a height of 9 mm, and then a second hot compression process that simulated finish forging at 1000° C., 900° C. or 800° C. to a height of 6 mm. Thereafter, the specimen was held at 700° C. or 650° C. for 30 minutes before being air-cooled to room temperature.

Each of the test specimens as cooled had a microstructure mainly composed of ferrite-pearlite. Specifically, the proportion in area of ferrite-pearlite was not lower than 95%.

Specimens for observation were extracted from the as-cooled test specimens, and the fraction of ferrite and Vickers hardness for a location near the center of each specimen were measured. The test results are shown in Tables 2 and 3. The values in the column labeled “Prior γ grain diam. after induction hardening” in Tables 2 and 3 are estimates derived from test results of steel materials of the same types (described further below).

TABLE 2

| | | Forging conditions | | | | | | | Prior γ |
|---|---|---|---|---|---|---|---|---|---|
| | | Heating | Temp. immed. | | Avg. | | | | grain diam. |
| | | temp. for | bef. Finish | Retention | cooling | | | | after induction |
| | Steel | hot forging | forging | conditions | rate | | Fα | Hardness | hardening# |
| No. | type | (° C.) | (° C.) | after forging | (° C./s) | F1 | (%) | (HV) | (μm) |
| 1 | B | 1250 | 1000 | 700° C. × 30 min | 0.05 | 27 | 40 | 245 | 15 |
| 2 | B | 1250 | 900 | 700° C. × 30 min | 0.05 | 27 | 34 | 234 | 12 |
| 3 | B | 1250 | 1000 | 650° C. × 30 min | 0.07 | 27 | 44 | 216 | 15 |
| 4 | B | 1250 | 900 | 650° C. × 30 min | 0.07 | 27 | 36 | 212 | 12 |
| 5 | D | 1250 | 1000 | 700° C. × 30 min | 0.05 | 7.5 | 10 | 297 | 27 |
| 6 | D | 1250 | 900 | 700° C. × 30 min | 0.05 | 7.5 | 18 | 267 | 24 |
| 7 | D | 1250 | 1000 | 650° C. × 30 min | 0.07 | 7.5 | 11 | 255 | 27 |
| 8 | D | 1250 | 900 | 650° C. × 30 min | 0.07 | 7.5 | 18 | 251 | 24 |
| 9 | E | 1250 | 1000 | 700° C. × 30 min | 0.05 | 7.5 | 19 | 278 | 18 |
| 10 | E | 1250 | 900 | 700° C. × 30 min | 0.05 | 7.5 | 21 | 266 | 12 |
| 11 | E | 1250 | 1000 | 650° C. × 30 min | 0.07 | 7.5 | 23 | 244 | 18 |
| 12 | E | 1250 | 900 | 650° C. × 30 min | 0.07 | 7.5 | 16 | 244 | 12 |

F1 = −150 × [C %] + 84
#Estimated values

TABLE 3

| | | Forging conditions | | | | | | | Prior γ |
|---|---|---|---|---|---|---|---|---|---|
| | | Heating | Temp. immed. | | Avg. | | | | grain diam. |
| | | temp. for | bef. Finish | Retention | cooling | | | | after induction |
| | Steel | hot forging | forging | conditions | rate | | Fα | Hardness | hardening# |
| No. | type | (° C.) | (° C.) | after forging | (° C./s) | F1 | (%) | (HV) | (μm) |
| 13 | A | 1250 | 1100 | n/a | 0.4 | 27 | 18 | 235 | 42 |
| 14 | A | 1250 | 900 | n/a | 0.4 | 27 | 32 | 232 | 42 |
| 15 | A | 1250 | 1100 | 700° C. × 30 min | 0.05 | 27 | 26 | 244 | 42 |
| 16 | A | 1250 | 900 | 700° C. × 30 min | 0.05 | 27 | 42 | 223 | 42 |
| 17 | A | 1250 | 1100 | 650° C. × 30 min | 0.07 | 27 | 20 | 215 | 42 |
| 18 | A | 1250 | 900 | 650° C. × 30 min | 0.07 | 27 | 35 | 209 | 42 |
| 19 | B | 1250 | 900 | n/a | 0.4 | 27 | 23 | 229 | 12 |
| 20 | B | 1250 | 800 | n/a | 0.4 | 27 | 30 | 243 | 8 |
| 21 | B | 1250 | 800 | 700° C. × 30 min | 0.05 | 27 | 39 | 248 | 8 |
| 22 | B | 1250 | 800 | 650° C. × 30 min | 0.07 | 27 | 27 | 234 | 8 |
| 23 | C | 1250 | 1100 | n/a | 0.4 | 7.5 | 6 | 295 | 35 |
| 24 | C | 1250 | 900 | n/a | 0.4 | 7.5 | 9 | 278 | 35 |
| 25 | C | 1250 | 1100 | 700° C. × 30 min | 0.05 | 7.5 | 8 | 284 | 35 |
| 26 | C | 1250 | 900 | 700° C. × 30 min | 0.05 | 7.5 | 13 | 278 | 35 |
| 27 | C | 1250 | 1100 | 650° C. × 30 min | 0.07 | 7.5 | 7 | 254 | 35 |
| 28 | C | 1250 | 900 | 650° C. × 30 min | 0.07 | 7.5 | 12 | 249 | 35 |
| 29 | D | 1250 | 1100 | n/a | 0.4 | 7.5 | 2 | 303 | 28 |
| 30 | D | 1250 | 1000 | n/a | 0.4 | 7.5 | 7 | 299 | 27 |
| 31 | D | 1250 | 1100 | 700° C. × 30 min | 0.05 | 7.5 | 6 | 302 | 28 |
| 32 | D | 1250 | 800 | 700° C. × 30 min | 0.05 | 7.5 | 13 | 272 | 23 |
| 33 | D | 1250 | 1100 | 650° C. × 30 min | 0.07 | 7.5 | 6 | 265 | 28 |
| 34 | D | 1250 | 800 | 650° C. × 30 min | 0.07 | 7.5 | 14 | 260 | 23 |
| 35 | E | 1250 | 1100 | n/a | 0.4 | 7.5 | 7 | 321 | 20 |
| 36 | E | 1250 | 800 | n/a | 0.4 | 7.5 | 12 | 288 | 10 |
| 37 | E | 1250 | 1100 | 700° C. × 30 min | 0.05 | 7.5 | 6 | 323 | 20 |
| 38 | E | 1250 | 800 | 700° C. × 30 min | 0.05 | 7.5 | 13 | 257 | 10 |
| 39 | E | 1250 | 800 | 650° C. × 30 min | 0.07 | 7.5 | 14 | 264 | 10 |

F1 = −150 × [C %] + 84
#Estimated values

As shown in Table 2, each of the test specimens labeled Nos. 1 to 12 had a fraction of ferrite satisfying expression (1).

Nos. 13, 23, 29, 30 and 35 are test specimens to which the heat pattern of FIG. 2 was applied. Each of these test specimens had a low fraction of ferrite, and failed to satisfy expression (1).

Each of the test specimens labeled Nos. 15, 17, 27, 31, 33 and 37 had a low fraction of ferrite and failed to satisfy expression (1). This is presumably because the finish forging temperature was too high.

Each of the test specimens labeled Nos. 20, 21, 22, 32, 34, 36, 38 and 39 had a fraction of ferrite satisfying expression (1). However, since the finish forging temperature was low, it is assumed that applying these examples in actual production is difficult, if not impossible.

Each of the test specimens labeled Nos. 13 to 18 and 23 to 28 had too low an Nb content; it is assumed that the prior γ grain diameter after induction hardening is larger than 30 μm, as a result.

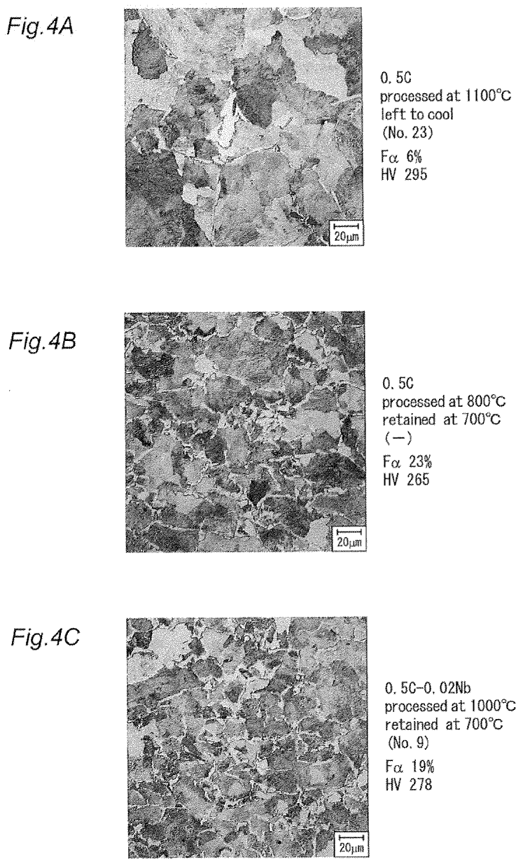

FIG. 4A shows the microstructure of the test specimen labeled No. 23. FIG. 4B shows the microstructure of a test specimen made of the same steel material as for FIG. 4A and that experienced a finish-forging temperature of 800° C. and was retained at 700° C. for 30 minutes. FIG. 4C shows the microstructure of the test specimen labeled No. 9. The portions that appear white in the photographs represent ferrite.

A comparison between FIGS. 4A and 4B demonstrates that decreasing the finish-forging temperature increases the fraction of ferrite. Further, a look at FIG. 4C demonstrates that, with a steel containing Nb, even if the finish-forging temperature is raised to 1000° C., a fraction of ferrite can be obtained that is generally equal to that of the test specimen of FIG. 4B, which experienced a finish-forging temperature of 800° C.

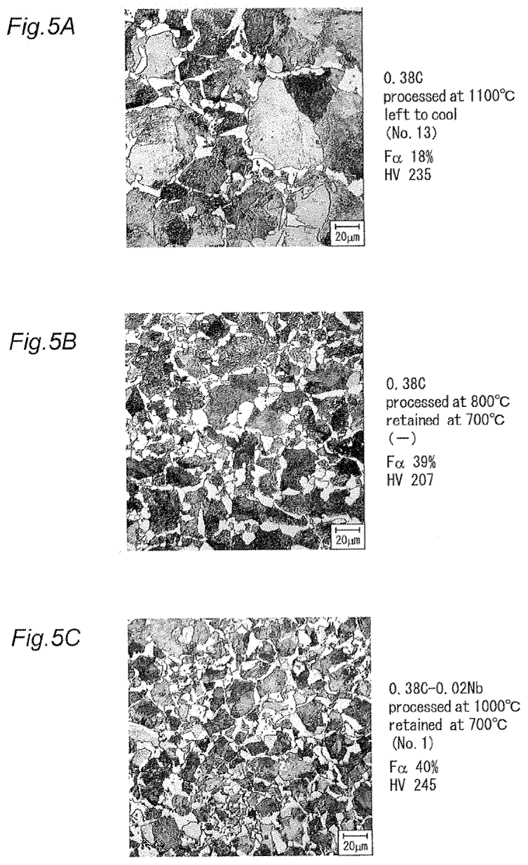

FIG. 5A shows the microstructure of the test specimen labeled No. 13. FIG. 5B shows the microstructure of a test specimen made of the same steel material as for FIG. 5A and that experienced a finish-forging temperature of 800° C. and was retained at 700° C. for 30 minutes. FIG. 5C shows the microstructure of the test specimen labeled No. 1. As is the case with FIGS. 4A to 4C, the portions that appear white represent ferrite. Again, it can be understood that, with a steel containing Nb, even if the finish-forging temperature is raised to 1000° C., a fraction of ferrite can be obtained that is generally equal to that of a test specimen that experienced a finish-forging temperature of 800° C.

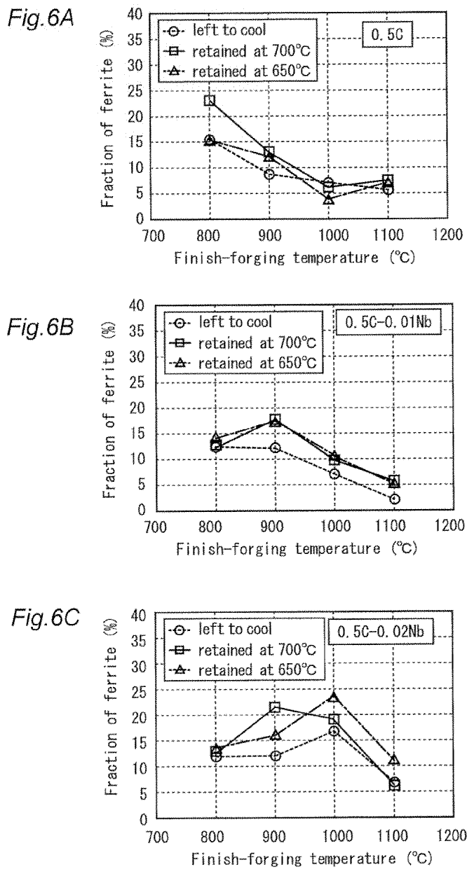

FIGS. 6A to 6C are graphs showing the relationship between the finish-forging temperature for steel types C to E and the fraction of ferrite of these steels, respectively. FIGS. 6A to 6C demonstrate that, as Nb content increases, finish-forging temperatures that provide large fractions of ferrite shift toward higher regions.

It is noted that, for steel types D and E, the fraction of ferrite resulting from the finish-forging temperature of 800° C. is lower than that from the finish-forging temperature of 900° C. This is presumably because more non-recrystallized austenite was present. Recrystallized austenite grains are finer than austenite grains present prior to finish forging. On the other hand, non-recrystallized austenite takes over the structural unit of the original coarse austenite grains, and thus the number per unit area of crystal grain boundaries, which provide main ferrite nucleation sites, does not increase, leading to a decrease in fraction of ferrite.

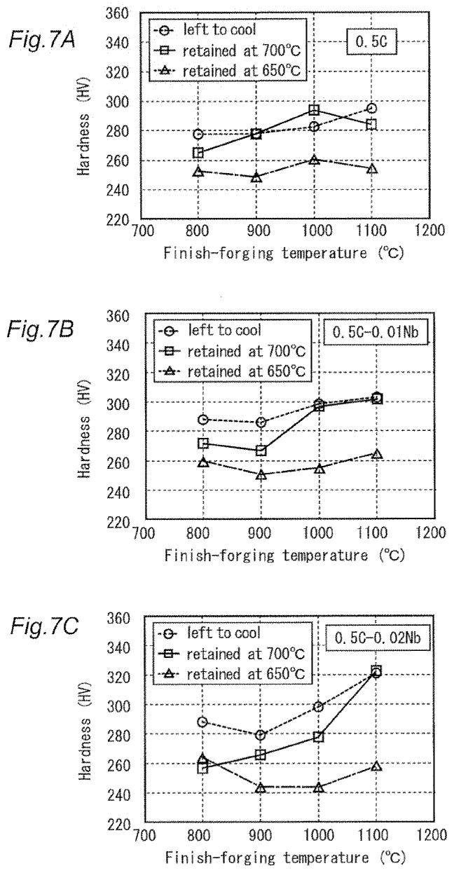

FIGS. 7A to 7C are graphs showing the relationship between the finish-forging temperature for steel types C to E and the Vickers hardness of these steels, respectively. FIGS. 7A to 7C demonstrate that Vickers hardness is significantly affected by retention temperature. The softening resulting from the retention at 700° C. occurred presumably because of an increase in fraction of ferrite. The softening resulting from the retention at 650° C. occurred presumably because of an increased fraction of ferrite and, in addition, an increased lamellar distance in pearlite.

FIGS. 6A to 6C and 7A to 7C demonstrate that fraction of ferrite and Vickers hardness can be controlled independently, to some degree, by choosing a combination of a chemical composition, a finish-forging temperature and a retention temperature.

These results prove that, if Nb is contained, a structure with high fraction of ferrite can be obtained without excessively reducing finish-forging temperature.

[Fatigue Testing]

Next, the relationship between the structure and fatigue property of a steel was investigated.

Steels with the chemical compositions shown in Table 4 were smelted by a 150 kg vacuum induction melting (VIM) furnace to produce ingots.

TABLE 4

| Steel | | Chemical composition (in mass %, balance Fe and impurities) | | | | | | | | |
|---|---|---|---|---|---|---|---|---|---|---|
| type | | C | Si | Mn | P | S | Cr | Al | Nb | N |
| A* | 0.38 C | 0.38 | 0.50 | 1.49 | 0.018 | 0.065 | 0.15 | 0.005 | — | 0.0040 |
| C* | 0.5 C | 0.51 | 0.48 | 1.49 | 0.017 | 0.064 | 0.15 | 0.004 | — | 0.0041 |
| E* | 0.5 C - 0.02 Nb | 0.50 | 0.49 | 1.48 | 0.011 | 0.062 | 0.15 | 0.002 | 0.020 | 0.0043 |

Hot forging was performed on these ingots to produce plate-shaped materials to be rolled with a thickness of 40 mm. These materials to be rolled were hot rolled under the conditions shown in Table 5.

TABLE 5

| Work conditions | Heating | Rough rolling | Finish rolling | Retention |
|---|---|---|---|---|
| Condition set 1 | 1250° C. | start at 1100° C. | not performed | not performed |
| | | 40-35-30-25-20 | | |
| Condition set 2 | 1250° C. | start at 1100° C. | start at 1000° C. | 700° C. × 30 min |
| | | 40-35-30 | 30-26-23-20 | |
| Condition set 3 | 1250° C. | start at 1100° C. | start at 850° C. | 700° C. × 30 min |
| | | 40-35-30 | 30-26-23-20 | |

Specifically, under condition set 1, the material was heated to 1250° C.; then, rough rolling was initiated at 1100° C. and the material was processed in 5 passes to a thickness of 20 mm before being air-cooled to room temperature. Under condition set 2, the material was heated to 1250° C.; then, rough rolling was initiated at 1100° C. and the material was processed in 3 passes to a thickness of 30 mm; finish rolling was then initiated at 1000° C. and the material was processed in 4 passes to a thickness of 20 mm. Thereafter, a retention process was performed where the material was held at 700° C. for 30 minutes, before being air-cooled to room temperature. Condition set 3 is the same as condition set 2 except for the finish-rolling initiation temperature of 850° C.

Test specimens for observation were extracted from the as-rolled steel plates, and fraction of ferrite and Vickers hardness were measured.

From the as-rolled steel plates were extracted type 14A test specimens specified by JIS Z 2241 (outer diameter: 8 mm; gauge-mark distance: 40 mm), and tensile testing was conducted.

From the as-rolled steel plates were extracted Ono's rotary bending fatigue test specimens (length: 106 mm; outer diameter of parallel portion: 8 mm; outer diameter of grip: 15 mm), and rotary bending fatigue testing was conducted.

The results are shown in Table 6. In Table 6, “0.2% PS” means 0.2% proof stress, and “TS” means tensile strength. “-” in Table 6 indicates that fatigue testing was not conducted on the relevant steel plate.

TABLE 6

| | | | | | | | | Fatigue | |
|---|---|---|---|---|---|---|---|---|---|
| | Steel | Rolling | Hardness | 0.2% PS | TS | | Fα | strength | Endurance |
| No. | type | conditions | (HV) | (MPa) | (MPa) | F1 | (%) | (MPa) | ratio |
| 1 | A* | Cond. set 1 | 220 | 423 | 757 | 27 | 13 | 330 | 0.44 |
| 2 | | Cond. set 2 | 207 | 415 | 709 | 27 | 41 | — | — |
| 3 | | Cond. set 3 | 206 | 427 | 728 | 27 | 41 | 340 | 0.47 |
| 4 | C* | Cond. set 1 | 251 | 475 | 865 | 7.5 | 2 | 380 | 0.44 |
| 5 | | Cond. set 2 | 247 | 474 | 862 | 7.5 | 7 | — | — |
| 6 | | Cond. set 3 | 242 | 445 | 789 | 7.5 | 12 | 380 | 0.48 |
| 7 | E* | Cond. set 1 | 272 | 569 | 925 | 9 | 3 | 420 | 0.45 |
| 8 | | Cond. set 2 | 256 | 507 | 880 | 9 | 9 | 440 | 0.50 |
| 9 | | Cond. set 3 | 245 | 493 | 869 | 9 | 7 | — | — |

F1 = −150 × [C %] + 84

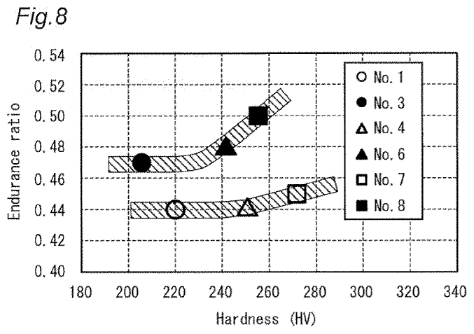

FIG. 8 is a graph showing the relationship between Vickers hardness and endurance ratio (fatigue strength/tensile strength). FIG. 8 demonstrates that the steel plates labeled Nos. 3, 6 and 8, having a fraction of pearlite satisfying expression (1), had higher endurance ratios than the steel plates labeled Nos. 1, 4 and 7, which did not satisfy expression (1).

These results prove that a fraction of pearlite satisfying expression (1) provides a steel that offers an excellent balance of fatigue strength and machinability.

[Induction-Hardening Simulation Testing]

Finally, the relationship between the chemical composition of a steel and the as-induction-hardened structure was investigated.

Steels having the same chemical compositions as steel types C to E in Table 1 were smelted by a 150 kg vacuum induction melting (VIM) furnace to produce ingots. These ingots were subjected to hot forging to produce round bars with an outer diameter of 35 mm. These round bars were subjected to a normalization process, in which the bars were held at 950° C. for 30 minutes and then air-cooled, to produce steel materials.

Test specimens with an outer diameter of 8 mm and a height of 12 mm were extracted from these steel materials, and hot-forging simulation experiments were conducted using a processing formastor. Specifically, each test specimen was held at 1250° C. for 10 minutes, and subjected to a hot compression process that simulated forging at 1100° C., 1000° C., 900° C. or 800° C. to a height of 6 mm before being air-cooled to room temperature. It is noted that these tests involved no retention or slow cooling after hot compression, because it is assumed that they hardly affect the structure after induction hardening.

Thereafter, a heat treatment that simulated induction hardening was performed, where the steel was heated to 1000° C. at a rate of temperature rise of 40° C./s, held at 1000° C. for 40 seconds, and cooled to room temperature at a cooling rate of about 40° C./s.

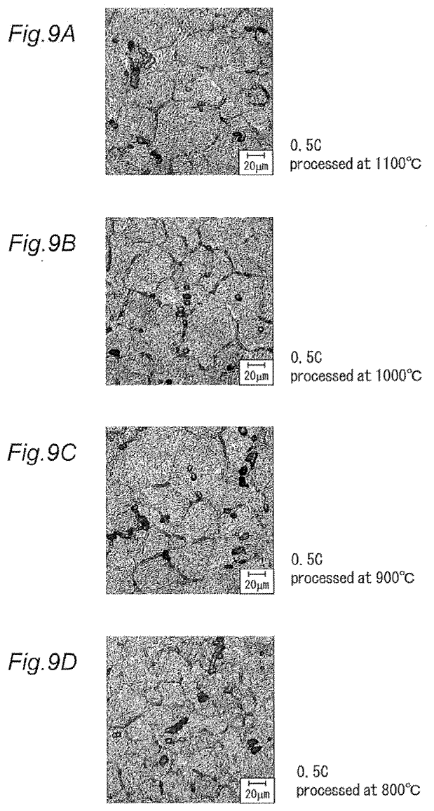

FIGS. 9A to 9D, 10A to 10D and 11A to 11D show microstructures of the test specimens after the simulated heat treatment by induction hardening.

FIGS. 9A to 9D demonstrate that the test specimen that had experienced the forging temperature of 800° C. had a prior γ grain diameter of about 30 μm, which means somewhat finer grains than in the other test specimens. On the other hand, the photographs demonstrate that the test specimens that had experienced the forging temperatures of 1100° C., 1000° C. and 900° C. all had coarsened prior γ grain diameters not smaller than 30 μm, with no significant differences.

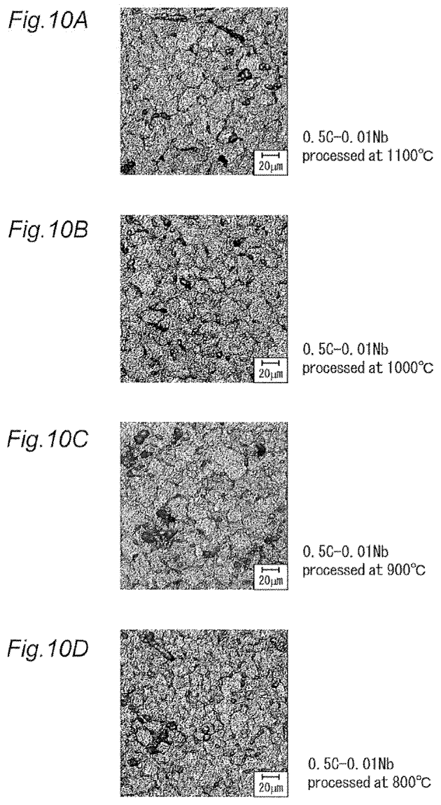

FIGS. 10A to 10D demonstrate that, if Nb is contained, the prior γ grain diameter becomes 30 μm or smaller, meaning significantly finer grains. Further, the photographs demonstrate that a test specimen containing Nb has a tendency that the structure becomes finer as the forging temperature decreases.

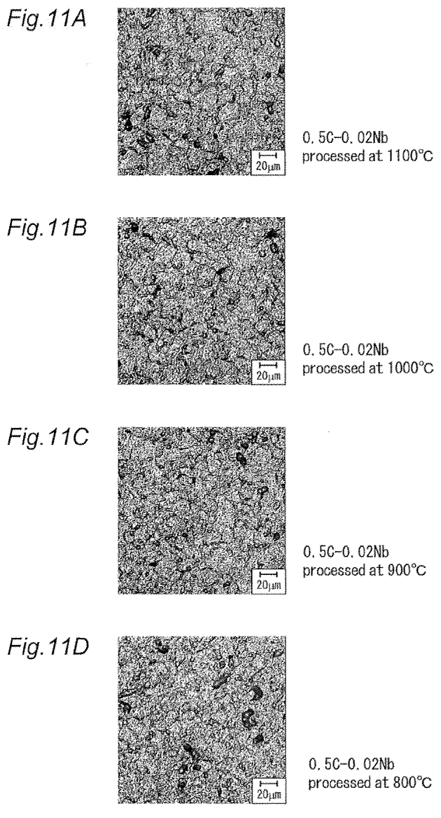

FIGS. 11A to 11D demonstrate that an increased Nb content resulted in finer structures than in FIGS. 10A to 10D. Further, similar to FIGS. 10A to 10D, the photographs demonstrate a tendency that the structure becomes finer as the forging temperature decreases. Particularly fine structures can be recognized for forging temperatures not higher than 1000° C., where the prior γ grain diameter was not larger than 20 μm.

These results prove that, if Nb is contained, the prior austenite grain diameter of the induction-hardened portions can be reduced.

Although embodiments of the present invention have been described, the above-described embodiments are exemplary only, intended to allow the present invention to be carried out. Accordingly, the present invention is not limited to the above-described embodiments, and the above-described embodiments, when carried out, may be modified as appropriate without departing from the spirit of the invention.

1. An induction-hardened crankshaft including a non-induction-hardened portion and an induction-hardened portion, having a chemical composition of, in mass %:
0.30 to 0.60% C;
0.01 to 1.50% Si;
0.4 to 2.0% Mn;
0.01 to 0.50% Cr;
0.001 to 0.06% Al;
0.001 to 0.02% N;
up to 0.03% P;
0.005 to 0.20% S;
0.005 to 0.060% Nb; and
balance Fe and impurities,
the non-induction-hardened portion having a microstructure mainly composed of ferrite-pearlite and having a fraction of ferrite Fα satisfying the expression (1) provided below,
the induction-hardened portion having a microstructure mainly composed of martensite or tempered martensite, and having a prior austenite grain diameter not larger than 30 μm,
Fα≥−150×[C %]+84 (1),
where the C content in mass % in the induction-hardened crankshaft is substituted for [C %].

2. A method of manufacturing a roughly shaped material for an induction-hardened crankshaft, comprising the steps of
preparing a steel material having a chemical composition of, in mass %: 0.30 to 0.60% C; 0.01 to 1.50% Si; 0.4 to 2.0% Mn; 0.01 to 0.50% Cr; 0.001 to 0.06% Al; 0.001 to 0.02% N; up to 0.03% P; 0.005 to 0.20% S;

0. 005 to 0.060% Nb; and balance Fe and impurities;
hot-forging the steel material in such a manner that, immediately before finish forging, the steel material is at a temperature higher than 800° C. and lower than 1100° C.; and,
after the hot forging, cooling the steel material at an average cooling rate not higher than 0.07° C./s through a temperature range of 800 to 650° C.
